(19) United States
(12) Patent Application Publication
(10) Pub. No.: US 2013/0329921 A1
(43) Pub. Date: Dec. 12, 2013

(54) OPTICALLY-CONTROLLED SPEAKER SYSTEM

(71) Applicant: Aptina Imaging Corporation, George Town (KY)

(72) Inventor: Kenneth Edward Salsman, Pleasanton, CA (US)

(21) Appl. No.: 13/906,982

(22) Filed: May 31, 2013

Related U.S. Application Data
(60) Provisional application No. 61/656,360, filed on Jun. 6, 2012.

(51) Int. Cl. H04S 7/00

(52) U.S. Cl. CPC H04S 7/303
USPC 381/303

(57) ABSTRACT

An acoustic system may be provided that includes image sensors and speakers. The system may include control circuitry that operates the speakers based on images captured by the image sensors. The control circuitry may operate the image sensors to capture images of users of the system in the listening environment, extract user attributes of the users from the captured images, and control the volume and phase of sounds generated by each of the speakers based on the extracted user attributes. The user attributes may include a location, a motion, a head height, a head tilt angle, a head rotational angle, the position of each ear of a user or other attributes of each user of the system. The control circuitry may operate the speakers to optimize the acoustic experience of each user by generating sounds based on the user attributes of that user.

This application claims the benefit of provisional patent application No. 61/656,360, filed Jun. 6, 2012, which is hereby incorporated by reference herein in its entirety.

### BACKGROUND

This relates generally to acoustic systems and, more particularly, to speaker systems with optically-controlled speakers.

Sound systems such as entertainment systems, speaker systems in televisions or computers, or other sound systems often have speakers for generating sound output for a user. In some systems, multiple speakers generate coordinated sounds to produce a stereo or surround sound experience for the user. However, the sound quality in these systems depends on the location of the user with respect to the speakers. Because the speakers are typically located in fixed positions and the user can be located in one or more variable positions with respect to the speakers, if care is not taken, a user may be provided with a sub-optimal sound experience. For example, a set of five speakers can be used to generate a surround sound experience for a user at a central location between the five speakers. However, if the user moves to one side of the room, or near an edge of the speaker system, a sub-optimal sound experience may result.

It may therefore be desirable to provide improved speaker systems that can adjust to the location and position of a user with respect to the speaker system.

### BRIEF DESCRIPTION OF THE DRAWINGS

FIG. 1 is a diagram of an illustrative optically-controlled sound system in accordance with an embodiment of the present invention.

FIG. 2 is a top view of an illustrative arrangement for an optically-controlled sound system in accordance with an embodiment of the present invention.

FIG. 3 is a diagram of a portion of an illustrative optically-controlled sound system showing how the system may adjust the output of one or more speakers based on a user's position, head height, and head tilt in accordance with an embodiment of the present invention.

FIG. 4 is a flow chart of illustrative steps that may be used in operating an optically-controlled sound system in accordance with an embodiment of the present invention.

FIG. 5 is a block diagram of a processor system employing the embodiment of FIG. 1 in accordance with an embodiment of the present invention.

### DETAILED DESCRIPTION

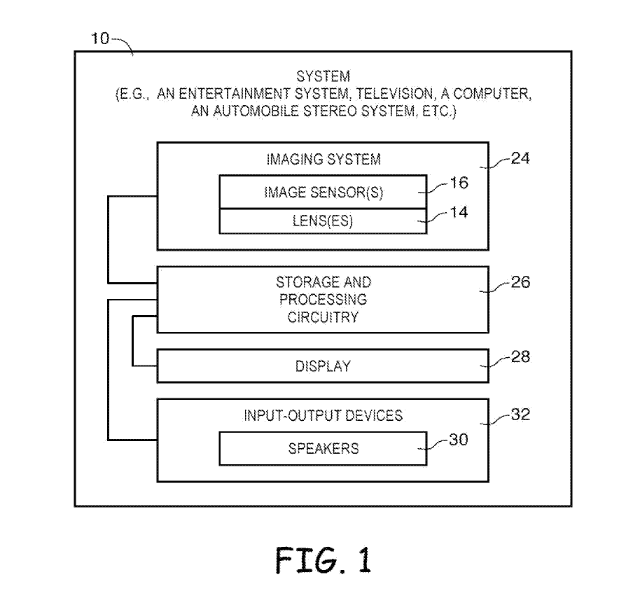

An illustrative system in which an imaging system may be used to control one or more speakers is shown in FIG. 1. As shown in FIG. 1, system 10 may include an imaging system such as imaging system 24 having one or more image sensors 16 and one or more corresponding lenses 14 that focus light onto image sensors 16. Each image sensor 16 may include one or more arrays of image sensor pixels based on complementary metal oxide semiconductor (CMOS) image pixel technology, charge-coupled-device (CCD) image sensor technology, or other image pixels for capturing images.

System 10 may include control circuitry such as storage and processing circuitry 26. Storage and processing circuitry 26 may be used to operate imaging system 24 to capture images of a scene, may be used to process image data from imaging system 24, and/or may be used to operate additional components of system 10 such as display 28 and/or input-output devices 32. Storage and processing circuitry 26 may include microprocessors, integrated circuits, memory circuits and other storage, etc.

Display 28 may be a liquid crystal display, a plasma display, an organic light-emitting diode display, a television, a computer monitor, a projection screen or other display based on other display technologies.

Input-output devices 32 may include one or more speakers 30 (e.g., subwoofers, woofers, tweeters, mid-range speakers, or speakers based on other types of speaker technology) that generate sounds based on musical data, video data, gaming data, or other data provide by circuitry 26 or one or more remote systems. Speakers 30 may form a portion of a stereo sound system, a surround sound system, an automobile sound system, a computer sound system, a movie theater sound system, a home theater sound system or other type of sound system.

In one suitable arrangement that is sometimes discussed herein as an example, speakers 30 form a surround sound system in which circuitry 26 controls the volume and phase of sound output from speakers 30 in a way that makes it seem to a user that different sounds are coming from different areas in the surrounding environment of a user. For example, when display 28 is being used to display a passing train moving toward the user on display 28, circuitry 26 may use speakers 30 to generate the sound of a train first using speakers located near display 28 and then using speakers behind the user to create the impression that the train has passed by the user.

Display 28 and/or input-output devices 32 may be operated by circuitry 26 based on images captured using imaging system 24. For example, imaging system may capture one or more images of a user of system 10. Circuitry 26 may process the captured images and determine user attributes such as the position of the user relative to the speakers, the height of the user's head, the tilt of the user's head, the location of other users, the movement of the users, or other user attributes from the captured images. Circuitry 26 may then generate sounds using speakers 30 that are based on the determined user attributes by adjusting the volume and/or the phase of musical sounds, movie sounds, or other sounds generated by each speaker.

For example, if it is determined that the user is located relatively closer to one edge of system 10, the volume of speakers near that edge may be reduced while the volume of speakers near an opposing edge may be increased to balance the sound based on the user position. In another example, the phase of sounds from each speaker may be adjusted to optimize surround sound effects for a user in a particular position. In yet another example, speakers 30 may be used to generate sounds that constructively interfere at the location of the user while destructively interfering at other locations so that the generated sounds are predominately heard at the location of the user while being quiet or imperceptible at other locations. In this type of example, a user that is operating system 10 in a gaming mode may be given secret instructions from the system that are not able to be heard by other competitors in the game.

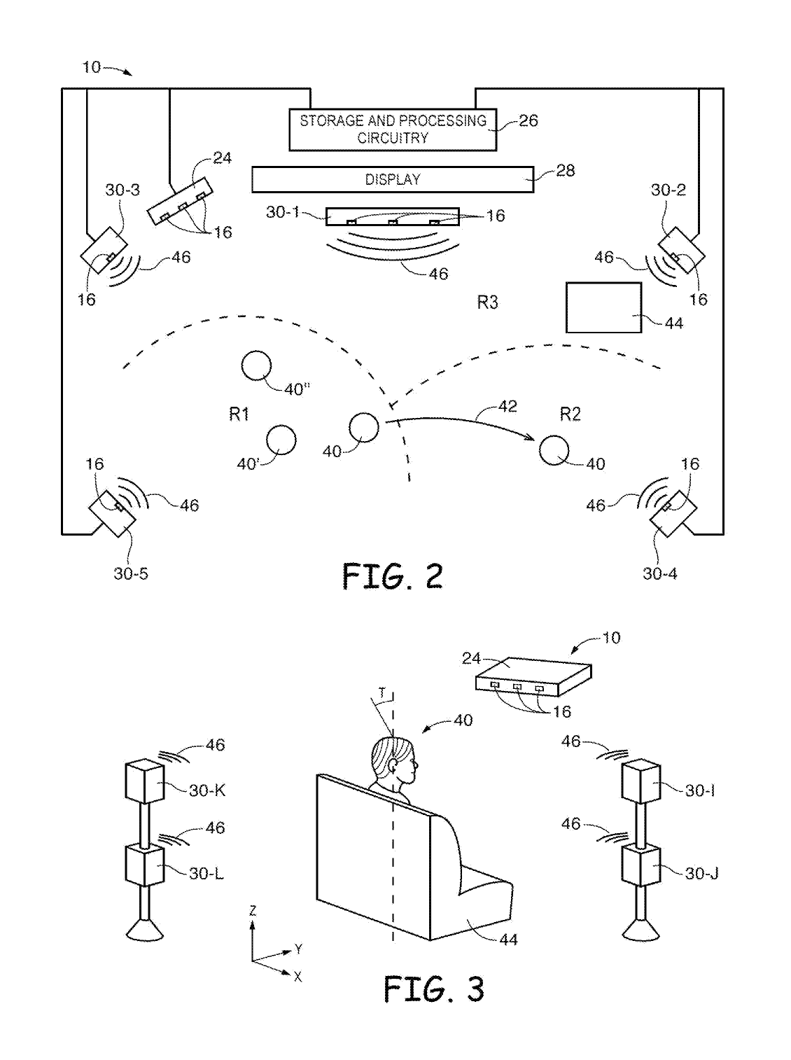

One example of a suitable arrangement for system 10 is shown in the top view of FIG. 2. As shown in FIG. 2, system 10 may include five speakers such as speakers 30-1, 30-2, 30-3, 30-4, and 30-5 configured in various positions that generate sound 46 for one or more users 40. The sounds generated by speakers 30 may be associated with video output on display 28 (e.g., movies, music videos, internet content, gaming content, etc.) or with other audio content such as recorded music. System 10 may include a separate imaging system 24 having one or more image sensors 16 for capturing images of user 40. However, this is merely illustrative. If desired, imaging system 24 may be partially or completely integrated into speakers 30 and/or display 28.

In the example of FIG. 2, each of speakers 30-2, 30-3, 30-4, and 30-5 have an image sensor 16 and speaker 30-1 includes three image sensors 16 for capturing images of users of system 10. In general system 10 may include any number of image sensors 16 in any number of suitable locations for determining the location of users 40 with respect to speakers 30.

Storage and processing circuitry 26 may operate one or more of image sensors 16 to capture images of user 40, other users such as users 40′ and 40″ and other objects such as object 44 (e.g., a chair, a seat, a couch, a table, a pet, a vase, a desk, or any other objects or obstacles) that may be located near speakers 30. Circuitry 26 may then adjust sound 46 being generated by each speaker to compensate for the presence of object 44 and/or to optimize the sound based on the location and orientation of user 40, user 40′, user 40″ and/or other users. Image sensors 16 may be used to continuously capture images during sound generation operations for system 10.

In one example, system 10 may determine using images captured using sensors 16 that users 40, 40′ and 40″ are all located within one region of a room (e.g., region R1) and that no other users are located in any other regions of the room (e.g., regions R2, R3, or other regions). Circuitry 26 may adjust sound 46 generated by speakers 30-1, 30-2, 30-3, 30-4, and/or 30-5 so that the volume, the sound quality, and the focal point of surround sound operations is located in region R1.

During sound generation operations, a user of system 10 such as user 40 may move from a first position to a second position with respect to speakers 30 (as indicated by arrow 42). Images sensors 16 may be used to continuously capture images of user 40 so that circuitry 26 can detect the movement of user 40 and adjust the sound generated by speakers 30 accordingly.

FIG. 3 is a diagram of a portion of system 10 showing how speakers 30 and imaging system 24 may be arranged to adjust the sound generated by system 10 based on the height and orientation of a user's head. As shown in FIG. 3, a user 40 may listen to sound 46 generated by speakers 30 (e.g., speakers 30-I, 30-J, 30-K, 30-L, and/or other speakers in system 10) from a sitting position on object 44 (as an example). Image sensors 16 of imaging system 24 may be used to capture images of user 40. The captured images may be processed and the position and height of the users head (e.g., an x position, a y-position, and a z-position of the users head in the coordinate system of FIG. 3) may be determined from the processed images.

If desired, other attributes of the user such as a tilt angle T or other rotational position coordinates of the users head may be extracted from the captured images. Sound 46 from each speaker 30 may be adjusted based on the measured user attributes (e.g., the x, y, z, tilt, or other coordinates associated with the user's head). If desired, facial-recognition operations may be performed on the captured images (e.g., using circuitry 26) so that sound 46 from speakers 30 is matched to a particular user's preferences and/or physical attributes. For example, one member of a family may prefer a sound balance that emphasizes bass sounds over treble sounds while other members of the family prefer a sound balance that emphasizes treble sounds over bass sounds. System 10 may recognize the particular user using the facial-recognition operations on the captured images and generate sounds 46 based on the preferred sound balance (for example) for that particular user.

Images sensors 16 may be used to continuously capture images of user 40 so that circuitry 26 can detect changes in the user attributes of user 40 (e.g., if the user turns their head, stands up, or otherwise changes position) and adjust the sound generated by speakers 30 based on the detected changes. For example, in response to detecting that a user is standing up from a seated position, speakers located at a relatively greater height (e.g., speakers 30-I and 30-K) may be used to generate more sound than speakers at a relatively smaller height (e.g., speakers 30-J and 30L).

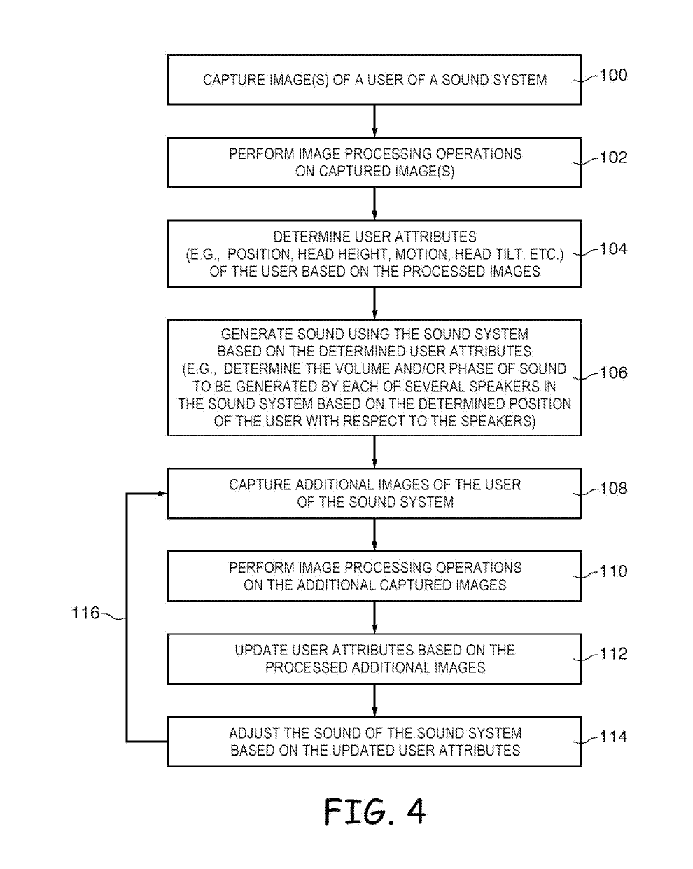

Illustrative steps that may be used in operating an optically-controlled sound system such as system 10 are shown in FIG. 4.

At step 100, one or more images of one or more users of a sound system such as system 10 may be captured (e.g., using one or more image sensors such as image sensors 16 of FIG. 1).

At step 102, image processing operations (e.g., edge detection operations, depth-mapping operations, motion-detection operations, facial-recognition operations, image enhancement operations, background removal operations, or other image processing operations) may be performed on the captured images.

At step 104, user attributes (e.g., a user position, a user head height, a user motion, a user head tilt, etc.) of the one or more users may be determined based on the processed images. Determining the user attributes may include determining an x-position, a y-position, a z-position, and an orientation of the head of a particular user, recognizing the identity of a particular user, and/or tracking the motion of a particular user (as examples).

At step 106, the sound system (e.g., speakers) may be used to generate sound (e.g., music, spoken words, background sounds, movie sounds, gaming sounds, etc.) based on the determined user attributes. For example, system 10 may determine the volume and/or phase of sound to be generated by each of several speakers in the sound system based on the determined position of the user with respect to the speakers.

System 10 may generate the sounds based on the user attributes by controlling the phase of sounds generated by the system so that, for example, a local zone of positive wavefront interaction is generated at the position of the user's ears. In this way, the overall volume of sound generated by each speaker can be low while the wavefronts from each speaker combine constructively to generate a local maximum that provides a local gain in volume at the location of the user. This type of phase adjustment can enhance the acoustic experience when system 10 is used in areas with a high background noise level, where privacy is desired, or where specific users would like to hear the sound while others would prefer it to be minimized. In this way, sounds for separate sound channels can also be generated at the location of separate ears of the user in order to provide an improved stereo and surround sound acoustical experience.

At step 108, the image sensors may be used to capture additional images of the user(s) of the system.

At step 110, image processing operations (e.g., edge detection operations, depth-mapping operations, motion-detection operations, facial-recognition operations, image enhancement operations, background removal operations, or other image processing operations) may be performed on the additional captured images.

At step 112, the determined user attributes may be updated based on the processed additional images (e.g., the position and/or orientation of the user's head with respect to the speakers may be updated to account for motion of the user).

At step 114, the sound of the sound system may be adjusted based on the updated user attributes (e.g., the volume and/or the phase of the sound generated by one or more speakers of the system may be changed to optimize the sounds for an updated position and/or orientation of the user).

As indicated by arrow 116, system 10 may return to step 108 and continuously capture images and adjust sounds based on the captured images during sound generation operations of the system.

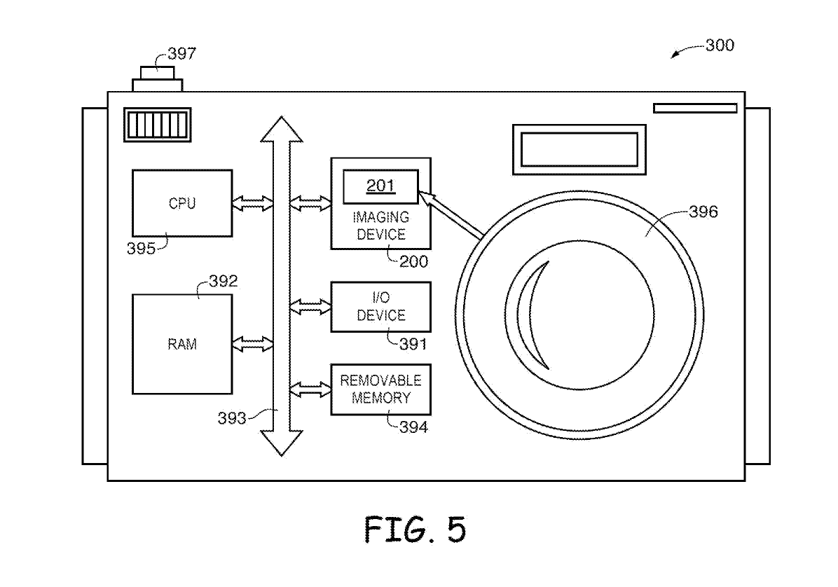

FIG. 5 shows, in simplified form, a typical processor system 300. Processor system 300 is exemplary of a system such as imaging system 24 having digital circuits that could include imaging device 200 (e.g., an image sensor in imaging system 24). Without being limiting, such a system could include a computer system, still or video camera system, scanner, machine vision, vehicle navigation, video phone, surveillance system, auto focus system, star tracker system, motion detection system, image stabilization system, video gaming system, video overlay system, and other systems employing an imaging device.

Processor system 300, which may be a digital still or video camera system, may include a lens such as lens 396 for focusing an image onto a pixel array such as pixel array 201 when shutter release button 397 is pressed (for example). Processor system 300 may include a central processing unit such as central processing unit (CPU) 395. CPU 395 may be a microprocessor that controls camera functions and one or more image flow functions and communicates with one or more input/output (I/O) devices 391 over a bus such as bus 393. Imaging device 200 may also communicate with CPU 395 over bus 393. System 300 may include random access memory (RAM) 392 and removable memory 394. Removable memory 394 may include flash memory that communicates with CPU 395 over bus 393. Imaging device 200 may be combined with CPU 395, with or without memory storage, on a single integrated circuit or on a different chip. Although bus 393 is illustrated as a single bus, it may be one or more buses or bridges or other communication paths used to interconnect the system components.

Image data from system 300 (e.g., from imaging device 200) may be processed using CPU 395 and RAM 392 and/or provided to external systems such as storage and processing circuitry 26 of system 10.

Various embodiments have been described illustrating a system having an imaging system with one or more image sensors, storage and processing circuitry, and one or more speakers. The computing equipment may include an imaging system, storage and processing circuitry, a display, communications circuitry, and input-output devices such as speakers. The imaging system may include one or more image sensors with a view of the listening environment.

The system may be implemented as an optically-controlled surround sound system in which the processing circuitry controls the sound generated by the speakers based on images captured by the image sensors. Image sensors may be formed in a separate imaging system or may be integrally formed with one or more of the speakers.

The image sensors may be used to capture images of one or more users of the system. The images may be processed and user attributes of the users may be extracted from the processed images. User attributes may include positions, orientations, head heights, head tilts, head rotational positions, identities, or any other suitable characteristics of each user of the system. Generating the sounds based on the user attributes may include setting and/or adjusting the volume and phase of each speaker to best provide the optimal acoustic experience for one or more users.

In some situations such as during gaming applications for system 10, the motion of the head as well as other user attributes can be detected and used to provide a three-dimensional sound environment for the users. In addition, imaging and depth mapping operations on the captured images may allow the system to map furniture and other obstacles in the environment and control the volume and phase of the sounds generated by the speakers to eliminate or minimize echoes and other undesirable acoustic effects due to the presence the obstacles.

In addition, the ability of the system to locate the user(s) may allow the system to control the phase of sounds generated by the system that, for example, can be used to generate a local zone of positive wavefront interaction at the position of the user's ears. In this manner, the overall volume of each speaker can be very low, but at the position of the user, the wavefronts can combine constructively to generate a local maximum that provides a local gain in volume for that user. This type of phase adjustment can enhance the acoustic experience when the system is used in areas with a high background noise level, in situations in which listening privacy is desired, or in situations in which specific users would like to hear the sound while others would prefer it to be minimized. Likewise, by identifying the position and orientation of the user's head and ears, it is possible to provide a high level of channel separation between each ear of the user.

The foregoing is merely illustrative of the principles of this invention which can be practiced in other embodiments.

What is claimed is:

1. An acoustic system, comprising:
an imaging system;
control circuitry; and
a plurality of speakers, wherein the imaging system is configured to capture images of a user and wherein the control circuitry is configured to operate the plurality of speakers based on the captured images of the user.

2. The acoustic system defined in claim 1, further comprising:
a display.

3. The acoustic system defined in claim 2 wherein the imaging system comprises a plurality of image sensors and wherein the control circuitry is configured to determine user attributes of the user based on the captured images of the user.

4. The acoustic system defined in claim 3 wherein the imaging system comprises a plurality of lenses that focus light onto the plurality of image sensors and wherein the control circuitry is configured to operate the plurality of speakers based on the determined user attributes.

5. The acoustic system defined in claim 4 wherein the control circuitry is configured to operate the plurality of speakers based on the determined user attributes by controlling a volume and a phase of sounds generated by the plurality of speakers based on the determined user attributes.

6. The acoustic system defined in claim 5 wherein the user attributes include a position of the user and wherein the control circuitry is configured control the volume and the phase of the sounds generated by the plurality of speakers to generate a local zone of positive wavefront interaction at the position of the user.

7. A method of operating an optically-controlled sound system having an imaging system and a plurality of speakers, the method comprising:
with the imaging system, capturing an image of a user;
determining at least one user attribute of the user based on the captured image; and
with the plurality of speakers, generating sound based on the determined at least one user attribute.

8. The method defined in claim 7, further comprising:
performing image processing operations on the captured image.

9. The method defined in claim 8 wherein performing the image processing operations on the captured image comprises performing depth-mapping operations on the captured image.

10. The method defined in claim 8 wherein performing the image processing operations on the captured image comprises performing motion-detection operations on the captured image.

11. The method defined in claim 8 wherein performing the image processing operations on the captured image comprises performing facial-recognition operations on the captured image.

12. The method defined in claim 8, further comprising:
capturing additional images of the user;
processing the additional captured images;
updating the determined at least one user attribute based on the processed additional captured images; and
adjusting the sound based on the updated at least one user attribute.

13. The method defined in claim 12 wherein determining at least one user attribute of the user based on the captured image comprises determining a location of the user with respect to the plurality of speakers.

14. The method defined in claim 13 wherein determining at least one user attribute of the user based on the captured image further comprises determining a head height of the user with respect to the plurality of speakers.

15. The method defined in claim 14 wherein determining at least one user attribute of the user based on the captured image comprises determining a head tilt angle of the user with respect to the plurality of speakers.

16. The method defined in claim 15 wherein determining at least one user attribute of the user based on the captured image comprises determining an identity of the user with respect to the plurality of speakers.

17. The method defined in claim 7 wherein generating the sound based on the determined at least one user attribute comprises generating a local zone of positive wavefront interaction at a determined position of the user.

18. A system, comprising:
a central processing unit;
memory;
input-output circuitry;
storage and processing circuitry;
an imaging device; and
a plurality of speakers, wherein the imaging device is configured to capture images and wherein the storage and processing circuitry is configured to operate the plurality of speakers based on the captured images.

19. The system defined in claim 18 wherein the storage and processing circuitry is configured to operate the plurality of speakers based on the captured images by controlling a volume of sound generated by each of the plurality of speakers based on the captured images.

20. The system defined in claim 19 wherein the storage and processing circuitry is further configured to operate the plurality of speakers based on the captured images by controlling a phase of the sound generated by each of the plurality of speakers based on the captured images.
